(19) United States
(12) Patent Application Publication
(10) Pub. No.: US 2023/0229958 A1
(43) Pub. Date: Jul. 20, 2023

(54) Probabilistic Loss Function Based Machine Learning System

(71) Applicant: Dell Products L.P., Round Rock, TX (US)

(72) Inventors: Arunachalam Muthu Valliappan, Austin, TX (US); Tejas Naren Tennur Narayanan, Austin, TX (US); Gautam Kaura, Austin, TX (US)

(21) Appl. No.: 17/576,851

(22) Filed: Jan. 14, 2022

(51) Int. Cl. G06N 20/00; G06F 17/18

(52) U.S. Cl. CPC G06N 20/00; G06F 17/18

(57) ABSTRACT

A probabilistic loss function based machine learning system (MLS) is disclosed. The MLS can generate an additional new class for uncertainty value(s) determined for inputs to the MLS. The uncertainty value(s) can be correlated to output(s) of the MLS. A novel loss function can be based on a conventional loss function, the uncertainty value(s), and an adjustable penalty value. The adjustable penalty value can be adjusted, such that improving the optimization of the novel loss function can cause the MLS to reduce use of computing resources in determining outputs corresponding to uncertainty value(s) above a threshold value(s) in favor of using computing resource for determining outputs corresponding to uncertainty value(s) below the threshold value(s). Updating of the adjustable penalty value can result in changes to the threshold value(s).

### BACKGROUND

Conventional machine learning (ML) technologies do not differentiate between outputs that are more probable to be accurate and those that are less probable to be accurate. In conventional ML system training, for example, a ML system can have higher ML output accuracy where ML inputs are more similar to the ML training inputs, e.g., where a training inputs are similar to in-use inputs, there can be more confidence that the outputs of the ML system will be accurate and, correspondingly, where in-use inputs are more dissimilar from training inputs, there can be a lower confidence that the outputs will be accurate. As an example, a conventional ML system trained with images of fish can be expected, when deployed, to identify input images of fish more accurately than input images of birds. As such, in conventional ML systems, data scientists can be required to spend a considerable amount of time building new methods to distinguish between the good output and bad output, for example, by selecting thresholds, etc. In addition to the extra time consumed, the use of post-training methods can fail to improve accuracy of the conventional ML system, e.g., the conventional ML system will continue to be less accurate at identifying bird images than fish images even where post-training methods can be applied. As such, conventional ML technologies can be expected to have longer development periods and be less effectively accurate than the presently disclosed subject matter, and conventional ML systems can therefore have increased time, increased cost, and lower performance than the presently disclosed subject matter.

### BRIEF DESCRIPTION OF DRAWINGS

FIG. 1 is an illustration of an example embodiment that can facilitate generating a machine learning output uncertainty probability based on machine learning inputs.

FIG. 2 is an illustration of one example embodiment that can enable employing an uncertainty probability in determining a loss value via a novel loss function.

FIG. 3 is an illustration of an example embodiment that can support use of an adjustable penalty value in determining an uncertainty probability that can be employable in determining a loss value via a novel loss function.

FIG. 4 is an illustration of an example embodiment that can enable adapting an adjustable penalty value useful for determining an uncertainty probability that can be employable in determining a loss value via a novel loss function.

FIG. 5 is an illustration of an example embodiment that can facilitate generating, via a novel loss function, loss values corresponding to uncertainty probabilities, wherein the loss values enable segregation of machine learning outputs.

FIG. 6 is an illustration of an example embodiment that can facilitate generating a machine learning output uncertainty probability based on machine learning inputs.

FIG. 7 is an illustration of an example embodiment facilitating generating a machine learning output uncertainty probability based on machine learning inputs and an adjustable penalty value.

FIG. 8 is an illustration of one example embodiment facilitating generating a machine learning output uncertainty probability based on machine learning inputs and an adjustable penalty value, wherein the adjustable penalty value is updateable based on batched losses of a loss function.

FIG. 9 depicts an example schematic block diagram of a computing environment with which an embodiment of the disclosed subject matter can interact.

FIG. 10 illustrates an example block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Generally, conventional ML systems do not differentiate between outputs based on a probability of the outputs being accurate, e.g., even though a ML system can have higher ML output accuracy where ML inputs are more similar to the ML training inputs, conventional ML systems typically do not use an adaptable uncertainly class based on ML inputs to segregate outputs according to probably accuracy of the output. Where, for example, a conventional ML system trained with images of fish can be expected, when deployed, to identify input images of fish more accurately than input images of birds, a probability that an output will be accurate can be based on inputs to the ML system, e.g., where the input image is more similar to training images, the output can have a higher probability of being accurate. Accordingly, in this example, an input image of a fish can result in a high confidence value that the output will be accurate, while an image of an input image of a kangaroo can result in a low confidence value that the output will be accurate. Conventional ML systems generally employ post-training technologies in an attempt to mitigate higher losses resulting from inaccurate outputs. These mitigations generally increase the time, cost, and complexity of conventional ML systems, especially in comparison to the presently disclosed subject matter. In an example, a conventional ML system is trained and then deployed. In this example ML system, inputs are used to generate outputs, but the outputs are generally not segregated according to a probability of output accuracy.

The presently disclosed subject matter can generate an additional output class indicating uncertainty for outputs based on the same inputs used to generate the outputs. In a manner of speaking, a ML: system according to the instant disclosure can indicate a level of confidence in an output based on the input to the ML system. Returning to the previous example of the ML system trained on fish images, receiving an image of a kangaroo can result in an indication of greater uncertainty that the output will be accurate, e.g., the image of the kangaroo can differ from the training fish images which can be correlated to a level of uncertainty for the kangaroo image that can indicate more uncertainty than an input image of new fish, which input image can be more similar to the training images. In another example, the disclosed subject matter can be likened to a poker player that can learn to recognize a hand that can be more likely to win, and the presently disclosed ML system can then “fold” when the uncertainty transitions an uncertainty threshold, e.g., in the above example, the presently disclosed ML system can segregate an output based on an input of a kangaroo, ‘folding’ based on the kangaroo image being sufficiently dissimilar from the training fish images.

The presently disclosed subject matter can segregate outputs according to a determined uncertainty probability. The uncertainty probability (UPS) can be employed in a novel loss function that can differ from conventional loss functions. The UPS can further be combined with a penalty value via the novel loss function. Where the presently disclosed ML system generates an output for inputs having an UPS above a threshold uncertainty value and does not generate an output for inputs having a UPS below the threshold, these instead being sent to a human expert to determine an output, and where the ML system adjusts the threshold uncertainty value to achieve a particular loss value from the novel loss function disclosed herein, the ML system can start to avoid generating outputs for ‘losing hands’ in the poker analogy, e.g., the ML system can converge on a state where many inputs do not result in outputs to avoid a high loss value and the ML system can increasingly ‘fold’ for all but the best ‘hands’. As an example, if the presently disclosed ML system , wherein the penalty value can be adapted to cause the presently disclosed ML system to generate an output. This can result in the disclosed ML system generating fewer outputs and sending more input cases to human experts for further analysis. This can be undesirable, and a penalty value can be implemented in the novel loss function to adjust the resulting loss values to cause the presently disclosed ML system to generate sufficient outputs. This ca be regarded as penalizing a poker player for folding, such as loss of an ante, so that the poker player does not only play the best hands, but also plays some hands with more uncertainty, albeit the poker player isn't likely to play every hand because some of the hands will have sufficiently uncertainty that the loss of the ante is preferable. In a like manner, the use of the penalty value can be used to adjust loss values from the novel loss function disclosed herein, which can result in the subject ML system adjusting which inputs result in outputs and which inputs are, for example, passed to a human expert. It is noted that inputs corresponding to low levels of confidence in an accuracy of an output can preferably be passed to a human expert to avoid use of an output that can have a low level of confidence in its accuracy. As an example, where the disclosed ML system distributes incoming phone calls to different customer service representatives, the ML system can waste a lot of time and customer goodwill by routing a call to a wrong customer service representative and, as such, where the ML system has a sufficiently low level of confidence that a correct customer service representative has been selected for the routing, it can be preferable to instead route the incoming call to a human expert to that can then determine which customer service representative is appropriate for the incoming call.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

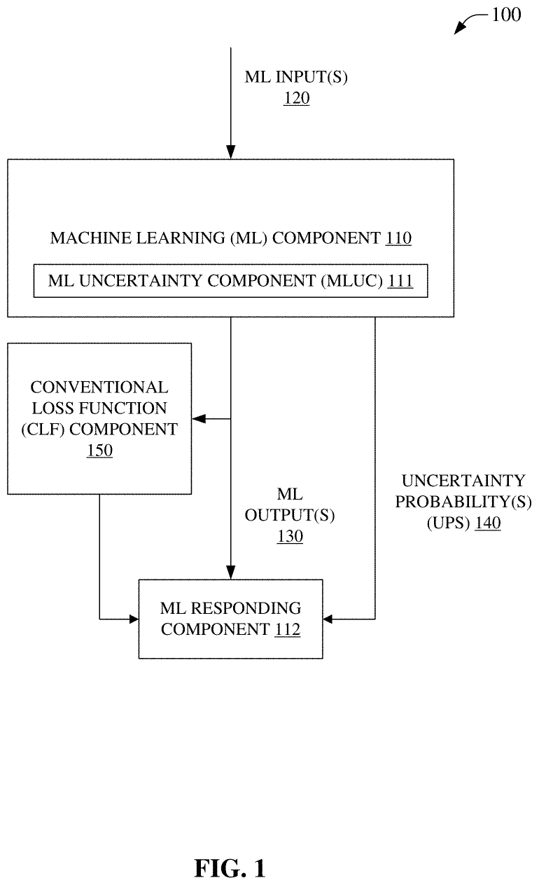

FIG. 1 is an illustration of a system 100, which can facilitate generating a machine learning output uncertainty probability based on machine learning inputs, in accordance with one or more embodiments of the subject disclosure. System 100 can comprise machine learning (ML) component 110 that can receive ML input(s) 120 and can generate ML outputs(s) 130. The term ‘machine learning,’ in some embodiments, can be inclusive of other intelligent computing, e.g., artificial intelligence, neural networks, probability theory, deep learning, etc., where germane to the disclosed embodiment, while most generally, machine learning can be employed to learn and predict outputs based on passive observation of inputs. ML component 110, similar to conventional ML technologies, can generate an ML output 130 based on one or more ML input 120. Additional, ML component 110 can comprise an ML uncertainty component (MLUC) 111, that can populate a new additional output class for uncertainty, which can be associated with an uncertainty threshold. In this regard, ML component 110, via MLUC 111, can generate uncertainty probability(ies) (UPS) 140.

Contemporary ML models typically cannot differentiate between outputs, e.g., between a first output having a greater probability of being accurate and a second output having a lower probability of being accurate, wherein the first output can be said to have less uncertainty or greater confidence, and wherein the second output can be said to have more uncertainty or lower confidence. Where the outputs of a conventional model are not segregated, data scientists can spend a considerable amount of time to design, test, implement, etc., methods to distinguish between outputs, e.g., filtering, thresholding, etc. In addition to this extra consumed time, these conventional methods can be less effective than the presently disclosed subject matter because the conventional methods are generally determined post-training, e.g., the conventional analysis of outputs typically does not occur during training of a conventional ML component. As such, the disclosed subject matter can be associated with expectations of shorter development periods with considerable improvements to effective accuracy, which can lead to savings in time, cost and improved performance of a ML models that comports with the presently disclosed subject matter. Generally, these ML model(s) can be employed in myriad environments, e.g., everywhere from assisting agents, improving operational efficiency, reducing cost, to improve customer interaction, etc., and, as such, a performance improvement over all such ML model(s) can enable improved customer experience, customer satisfaction, operational efficiency, etc.

In system 100, ML output(s) 130 can be received by conventional loss function (CLF) component 130, which can generate a conventional losses, e.g., a conventional loss column vector of a corresponding batch size. Accordingly, the output of ML component 110, e.g., ML output(s) 130, UPS 140, etc., can be received by a ML responding component 112, which can be nearly any component that would conventionally consume conventional ML outputs. As an example, a call center routing component can comprise a ML responding component 112, enabling the call center routing component to receive ML output(s) 130, and UPS 140 to facilitate routing of incoming calls to appropriate call center operators based on ML input(s) 120 that can be correlated to the incoming calls, e.g., incoming callers can navigate a phone tree to provide ML input(s) 120 to ML component 110 that can generate ML output(s) 130 and, via MLUC 111, can generate UPS 140, to enable the example call center routing component to direct the corresponding incoming call to an appropriate customer service representative. The ML responding component 112 can further receive conventional loss information from CLF component 150, such as in the preceding example, to facilitate call routing by the example call center routing component. In this regard, ML output(s) 130 can be associated with corresponding conventional loss information and with UPS 140, which can facilitate improved performance at ML responding component 112, e.g., UPS 140 can aid in making decisions based on confidence in an ML output of ML output(s) 130 and the loss information from CLF component 150. It is noted that UPS 140 is useful even at this level, even without further processing. However, as is further described herein, UPS 140 can be further employed to improve performance of an ML system, e.g., system 100, 200, etc.

In an embodiment, MLUC 111 can generate UPS 140, which can indicate an uncertainty corresponding to an output of ML output(s) 130. UPS 140 can be based on ML input(s) 120, e.g., a characteristic(s) of one or more input of ML input(s) 120, such as a level of similarity to a training input, etc. etc. Accordingly, UPS 140 can embody an uncertainty that a correct ML output(s) 130 is generated by MP component 110 for a corresponding ML input(s) 120. Returning to the previously mentioned poker game example, UPS 140 can be said to reflect a confidence that a given hand, e.g., ML input(s) 120, can result in a win, e.g., a correct ML output of ML output(s) 130. In an embodiment, where there is sufficient uncertainty, indicated by UPS 140, ML component 110 can avoid consuming computing resources to generate an output based on the corresponding ML input(s) 120, for example, passing that particular case to a human expert for further action rather than consuming computing resources to generate an output with said sufficiently high uncertainty that it will be a correct ML output. This can enable system 100 to ‘recognize’ input cases that have a threshold level of uncertainty and shunt those cases to other systems, human experts, etc., for further action, rather than wasting computing resources to generate an ML output with low confidence in accuracy of the ML output. In some embodiments, UPS 140 can be employed by ML: responding component 112 to adjust a level of reliance on a corresponding ML output of ML output(s) 130, e.g., where there is a threshold level of uncertainty indicated via UPS 140, the corresponding ML output can be, for example, ignored, passed to a human expert for further action, etc. In some embodiments, ML component 110 can comprise MLUC 111, while in some embodiments, MLUC 111 can be separate from, but in communication with, ML component 110, see system 400 where MLUC 411 is external to ML component 410, etc.

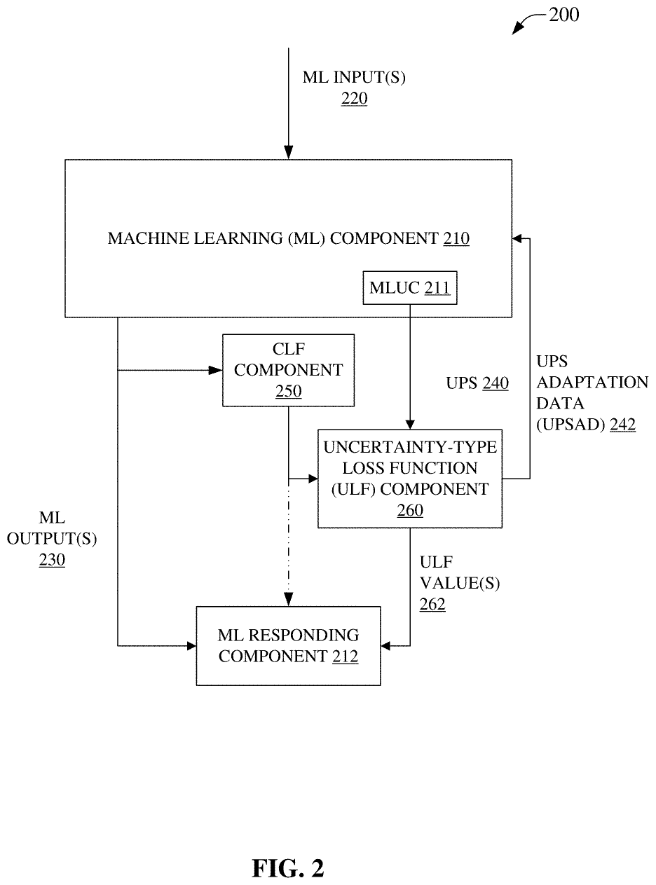

FIG. 2 is an illustration of an example system 200 enabling employing an uncertainty probability in determining a loss value via a novel loss function, in accordance with one or more embodiments of the subject disclosure. System 200 can comprise ML component 210 that can receive ML input(s) 220 and can generate ML output(s) 230. In embodiments, ML component 210 can comprise MLUC 211 that can generate UPS 240, which can indicate uncertainty that an output of the ML output(s) 230 is accurate based on ML input(s) 220. UPS 240 can be received by uncertainty-type loss function (ULF) component 260.

ULF component 260 can determine loss values based on UPS 240 from MLUC 211. In embodiments, ULF component 260 can generate UPS adaptation data (UPSAD) 242, which can be communicated back to ML component 210, enabling adjustment of a ML model employed by ML component 210, and can further result in adapting MLUC 211 to update, improve, adjust, etc., generation of UPS 240, e.g., UPSAD 242 can be fed back to ML component 210, and thus also MLUC 211, to update the corresponding ML model and further update generation of UPS 240. This can act to improve the accuracy of uncertainty information represented in ML output(s) 230, UPS 240, or combinations thereof. In embodiments, the support of UPSAD 242 to enable additional, on-going, etc., training of ML component 210 and/or MLUC 211 via the feedback of UPSAD 242, supports subsequent ML output(s) 230 and/or UPS 240 being more accurate by converging on minimization of the herein disclosed new loss function, e.g., L_{new}(xⱼ) , etc., more especially in regard to uncertainties associated with ML output(s) 230 based on ML input(s) 220.

In embodiments, ULF component 260 can generate ULF value(s) 262 that can be similar to loss values generated by CLF component 250. In this regard, ULF component 260 can comprise CLF 250 in some embodiments, or, as illustrated, CLF component 250 can be communicatively coupled to ULF component 260 to receive conventional loss information therefrom. The dashed line between CLF component 250 and ML responding component 212 can indicate that conventional loss data can be communicated to ML responding component 212 from CLF component 250 in some embodiments. However, said loss data can also be processed via ULF component 260, as indicated, and derivatives of CLF data can be reflected in ULF value(s) 262 generated by ULF component 260. As an example, ULF component 260 can employ the formula

L_{new}(xⱼ)=(1−p_{uncert})*L_{old}(xⱼ)+p_{uncert}*C_{penalty},

where L_{old}(xⱼ) is conventional loss function data, e.g., CLF data from CLF component 250, where p_{uncert} uncertainty information embodied in UPS 240, where C_{penalty} is a penalty value discussed in further detail elsewhere herein, and where L_{new}(xⱼ) is uncertainty based loss data derived from CLF data. As such, conventional loss functions can still be employed in the presently disclosed subject matter, e.g., via CLF component 250, etc., but resulting CLF data can be employed in determining ULF value(s) 262. ULF value(s) 262 can therefore include uncertainty information in resulting loss data vectors that can indicate uncertainties for outputs of UL output(s) 230. Accordingly, outputs corresponding to loss values transitioning a threshold level can be segregated from other outputs of ML output(s) 230. Segregated portions of ML output(s) 230 can then be subject to further actions that can, in embodiments, be distinct from other portions of ML output(s) 230. ML output(s) 230 can comprise full predictions based on ML input(s) 220, partial predictions based on ML input(s) 220, non-predictions, e.g., where ML component 210 ‘folds’ based on the uncertainty determined from ML input(s) 220 determined by MLUC 211, or combinations thereof.

In embodiments, ML responding component 212 can receive ML output(s) 230 and ULF value(s) 262. This can allow ML responding component 212 to take actions based on ULF value(s) 262 for corresponding portions of ML output(s) 230. As an example, where ML component 210 is trained on images of fish, an input of a kangaroo can result in MLUC 211 generating UPS 240 indicating that there is uncertainty corresponding to an output related to the kangaroo image input, e.g., because the kangaroo image can differ substantively from the fish training images, ML component 210 can ‘have less confidence that an out based on the kangaroo image will be accurate’. This information can be passed to ULF component 260 via UPS 240, which can result in ULF value(s) 262 designating an output of ML output(s) 230 corresponding to the kangaroo image input as having a lower level of confidence, e.g., segregating said corresponding output as ‘more uncertain’ than other outputs of ML output(s) 230. ML responding component 212 can then take an action based on the segregation of the kangaroo-image-based output, for example, sending that output to a human expert, etc. This example can illustrate that ML input(s) 220 can be employed, e.g., via MLUC 211, etc., to determine an associated uncertainty inherent in the corresponding output. In some embodiments, ML component 210 can entirely avoid generating an output for inputs having sufficient uncertainty determined by MLUC 211, however, even where a corresponding output is generated, this output can be segregated from other outputs having uncertainties that do not transition one or more threshold uncertainties.

Further, ULF component 260 can attempt to reduce waste of computing resources by reducing, truncating, etc., processing of inputs of ML input(s) 220 corresponding to sufficient uncertain values. In the previously mentioned poker analogy, ML component 210 can ‘fold’ where the hand, e.g., input(s), are determined to not be good enough to win the game, e.g., the corresponding output will transition an uncertainty threshold. In this analogy, ‘folding’ can be predicted where p_{uncert} is approaches a threshold uncertainty value, which can result in ML component 210 generating ML output(s) 230 with about an average loss for a corresponding conventional ML system. Moreover, where an output is generated, e.g., ML component 210 ‘decides to not fold where there is sufficiently low uncertainty, the resulting ML output(s) 230 would then depend on the predictions made based on training of ML component 210. Accordingly, applying the presently disclosed new loss function, e.g., via ULF component 260, can be regarded as training ML component 210, via UPSAD 242 updating of MLUC 211, to generate output for ‘good inputs,’ e.g., inputs the model is familiar with, etc., and ‘fold’ for the rest.

However, generating outputs for ‘good inputs’ and ‘folding’ for the rest can, in practice, result in a ‘reluctant’ ML component 210, e.g., ML component 210 can fold too often to be practicable in an attempt to avoid generating outputs for inputs corresponding to almost any level of uncertainty. This can be akin to a poker player only playing the very best hands and folding on all other hands, resulting in very few hands actually being played. Returning to the previously discussed call center example, if ML component 210 avoids almost all uncertainty, then almost all incoming calls can be routed to human experts for further action, which can be understood to be undesirable, e.g., where the ML component is deferring to a human expert most of the time, then it can be unclear why the ML component is being used at all in the example call center. However, much like an ante in the game of poker, in practice, use of a penalty value, e.g., C_{penalty}, can lead to the ML component 210 being forced to generate outputs for ML input(s) 220 corresponding to a selectable level of uncertainty at UPS 240. In the poker example, the ante is lost if the player folds, so folding has a cost associated with it. As such, in the poker example, a player will then play some less certain hands to avoid losing the ante, even where the less certain poker hand may still be a losing hand. Additionally, where the example poker hand is sufficiently uncertain, the player may opt to fold and lose the ante. Similarly, in the instant disclosure, the penalty value can act much like the poker ante and can cause ML component 210 to predict an output on inputs corresponding to greater uncertainty than without use of C_{penalty}. Additionally, where the uncertainty is sufficiently great, then ML component 210 can elect to avoid generating a prediction.

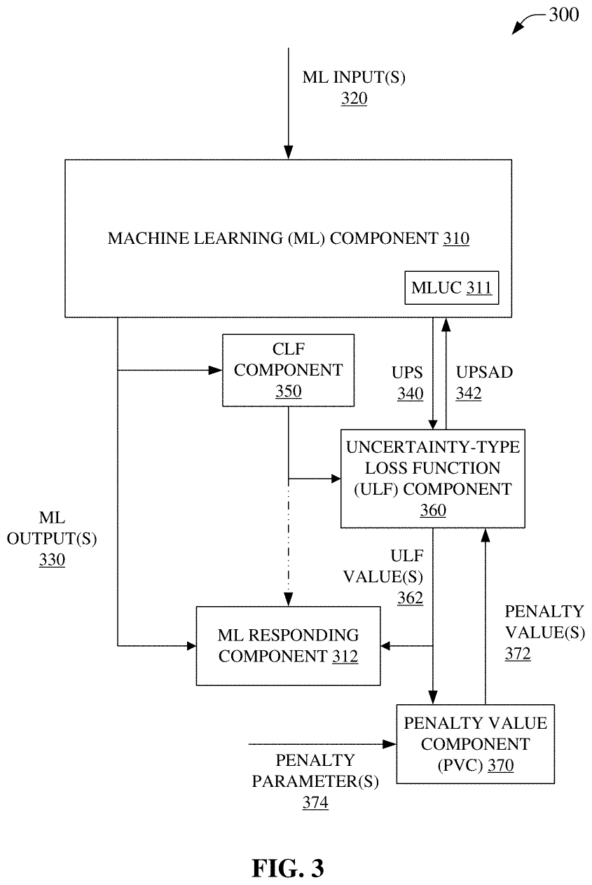

FIG. 3 is an illustration of a system 300, which can facilitate use of an adjustable penalty value in determining an uncertainty probability that can be employable in determining a loss value via a novel loss function, in accordance with embodiments of the subject disclosure. System 300 can comprise ML component 310 that can receive ML input(s) 320 and can generate ML output(s) 330. In embodiments, ML component 310 can comprise MLUC 311 that can generate UPS 340, which can indicate uncertainty that an output of the ML output(s) 330 is accurate based on ML input(s) 320. UPS 340 can be received by uncertainty-type loss function (ULF) component 360.

ULF component 360 can determine a loss value based on UPS 340 from MLUC 311. In embodiments, ULF component 360 can generate UPS adaptation data (UPSAD) 342, which can be communicated to ML component 310 and can result in adapting a corresponding ML model of ML component 310, adapting MLUC 311, etc., to update, improve, adjust, etc., generation of ML output(s) 330, UPS 340, etc., e.g., MLUC 311 can employ a feedback loop comprising UPSAD 342 to update generation of subsequent UPS 340. This can act to improve the accuracy of uncertainty information represented in UPS 340.

In embodiments, ULF component 360 can generate ULF value(s) 362 that can be based on loss values generated by CLF component 350. In some embodiments, CLF component 350 can be communicatively coupled to ULF component 360 to receive conventional loss information therefrom, while in other embodiments, ULF component 360 can instead comprise CLF 350. The dashed line between CLF component 350 and ML responding component 312 can indicate that conventional loss data can be communicated to ML responding component 312 from CLF component 350. Moreover, said loss data can also be processed via ULF component 360, as indicated, and derivatives of CLF data can be embodied as ULF value(s) 362 generated by ULF component 360. As an example, ULF component 360 can employ the formula

L_{new}(xⱼ)=(1−p_{uncert})*L_{old}(xⱼ)+p_{uncert}*C_{penalty},

where L_{old}(xⱼ) is conventional loss function data, e.g., CLF data from CLF component 350, where p_{uncert} uncertainty information embodied in UPS 340, where C_{penalty} is a penalty value that can be accessed from penalty value(s) 372 generated by penalty value component (PVC) 370, and where L_{new}(xⱼ) is uncertainty based loss data derived from CLF data. As such, conventional loss functions can be employed in the presently disclosed subject matter, e.g., via CLF component 350, etc., and resulting CLF data can be employed in determining ULF value(s) 362. ULF value(s) 362 can therefore include uncertainty information in resulting loss data vectors that can indicate uncertainties for outputs of UL output(s) 330. Accordingly, outputs corresponding to loss values transitioning a threshold level can be segregated from other outputs of ML output(s) 330. Segregated portions of ML output(s) 330 can then be subject to further actions that can, in embodiments, be distinct from other portions of ML output(s) 330.

In embodiments, ML responding component 312 can receive ML output(s) 330 and ULF value(s) 362. This can allow ML responding component 312 to respond to ULF value(s) 362 in regard to corresponding portions of ML output(s) 330. Similar to the example presented in system 200, where ML component 310 is trained on images of fish, an input of a kangaroo can result in MLUC 311 generating UPS 340 indicating that there is uncertainty corresponding to an output related to the kangaroo image input, e.g., because the kangaroo image can differ substantively from the fish training images, ML component 310 can ‘have less confidence that an out based on the kangaroo image will be accurate’. This information can be passed to ULF component 360 via UPS 340, which can result in ULF value(s) 362 designating an output of ML output(s) 330 corresponding to the kangaroo image input as having a lower level of confidence, e.g., segregating said corresponding output as ‘more uncertain’ than other outputs of ML output(s) 330. ML responding component 312 can then take an action based on the segregation of the kangaroo-image-based output, for example, sending that output to a human expert, etc. This example can illustrate that ML input(s) 320 can be employed, e.g., via MLUC 311, etc., to determine an associated uncertainty inherent in the corresponding output. In some embodiments, ML component 310 can entirely avoid generating an output for inputs having sufficient uncertainty determined by MLUC 311. However, the use of penalty value(s) 372 can cause ML component 310 to generate predictions via ML output(s) 330 even where the corresponding output can be more moderately uncertain, e.g., in accord with the previously mentioned poker analogy, ML component 310 can ‘fold’ where the hand, e.g., input(s), are determined to not be good enough to likely win the game, e.g., the corresponding output will transition an uncertainty threshold. Again, in this analogy, ‘folding’ can be predicted where p_{uncert} is approaches a threshold uncertainty value, which can result in ML component 310 generating ML output(s) 330 with about an average loss for a corresponding conventional ML system. However, generating outputs for ‘good inputs’ and ‘folding’ for the rest can again, in practice, result in a ‘reluctant’ ML component 310, e.g., ML component 310 can fold too often to be practicable in an attempt to avoid generating outputs for inputs corresponding to almost any level of uncertainty. This can be akin to a poker player only playing the very best hands and folding on all other hands, resulting in very few hands actually being played. As such, penalty value(s) 372 comprising C_{penalty}, much like an ante in the game of poker, can result in ML component 310 generating outputs for more ML input(s) 320 than without the penalty value, in accord with the example illustrative formula. The presently disclosed penalty value can act much like the poker ante and can cause ML component 310 to predict an output based on inputs corresponding to greater uncertainty than without use of C_{penalty}. Additionally, where the uncertainty is sufficiently great, then ML component 310 can elect to avoid generating a prediction.

PVC 370 can receive penalty parameters(s) 374 and can determine penalty value(s) based on penalty parameter(s) 374, ULF value(s) 362, or combinations thereof. As an example, penalty parameter(s) 374 can comprise an initial penalty value, such as an arbitrarily high initial penalty value that can employed to allow PVC 370 to converge on a subsequent penalty value, such as when training ML component 310 comprising MLUC 311. In this regard, where the initial penalty value is set extremely high, ML component 310 can favor generating predictive outputs for almost all inputs to avoid the penalty, e.g., the new loss function can have a loss value vector dominated by the penalty value and avoiding generation of outputs, even those with higher uncertainties, need not occur. However, using a high initial penalty value to ‘force’ ML component 310 into generating outputs is not a desirable continuous state, e.g., in the poker game analogy, while playing nearly no hands is undesirable, so is playing all hands and ignoring the probability that a hand will lose. As such, the penalty value can be adapted, for example, according to the formula :

C_{penalty}=mean(L_{old}(x_{batch}_{ⱼ})),

where L_{old} (x_{batch}_{ⱼ}) is the average loss according to CLF component 350. It is noted that C_{penalty} can be kept above a floor value to avoid cases where the penalty value goes to zero and the incentive to generate predictive outputs for all but the lowest uncertainties reoccurs, e.g., the penalty value from the above formula can be subject to a further rule such as C_{penalty}=max(C_{penalty}, Cₘᵢₙ), where Cₘᵢₙ is selectable and is treated as a minimum permitted penalty value permitted.

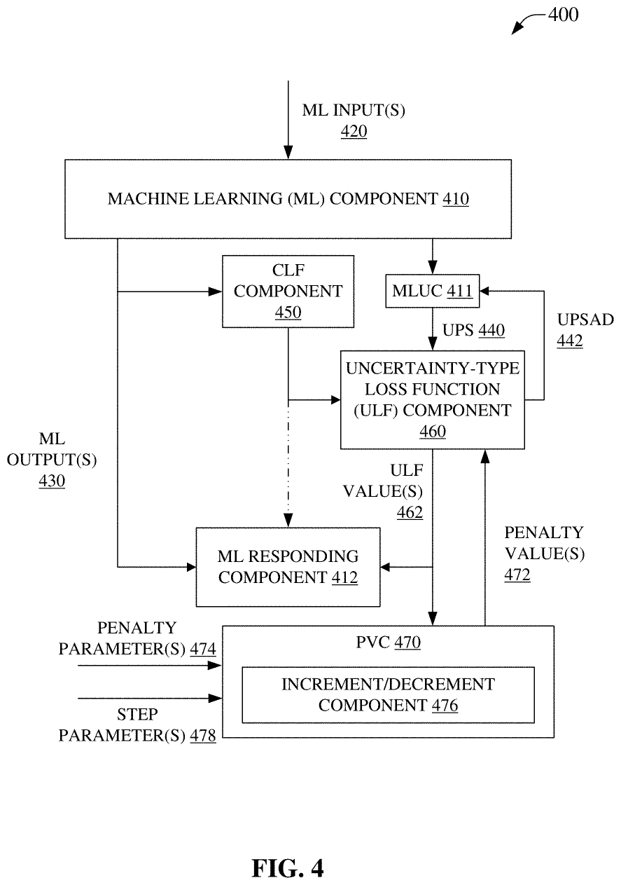

FIG. 4 is an illustration of a system 400 that can enable adapting an adjustable penalty value useful for determining an uncertainty probability that can be employable in determining a loss value via a novel loss function, in accordance with embodiments of the subject disclosure. System 400 can comprise ML component 410 that can receive ML input(s) 420 and can generate ML output(s) 430. While in some embodiments ML component 410 can comprise MLUC 411 that can generate UPS 440, which can indicate uncertainty that an output of the ML output(s) 430 is accurate based on ML input(s) 420, system 400 illustrates an embodiment in which MLUC 411 is a separate component communicatively coupled to ML component 410. UPS 440 can be received by uncertainty-type loss function (ULF) component 460.

ULF component 460 can determine a loss value based on UPS 440 from MLUC 411. In embodiments, ULF component 460 can generate UPS adaptation data (UPSAD) 442, which can be communicated to ML component 410, MLUC 411, etc., and can result in adapting a corresponding ML model, ML component 410, MLUC 411, etc., to update, improve, adjust, etc., generation of ML output(s) 430, UPS 440, etc., e.g., MLUC 411 can employ a feedback loop comprising UPSAD 442 to update generation of subsequent UPS 440. This can act to improve the accuracy of uncertainty information represented in UPS 440.

In embodiments, ULF component 460 can generate ULF value(s) 462 that can be based on loss values generated by CLF component 450. In some embodiments, CLF component 450 can be communicatively coupled to ULF component 460 to receive conventional loss information therefrom, while in other embodiments, ULF component 460 can instead comprise CLF 450. The dashed line between CLF component 450 and ML responding component 412 can indicate that conventional loss data can be communicated to ML responding component 412 from CLF component 450. Moreover, said loss data can also be processed via ULF component 460, as indicated, and derivatives of CLF data can be embodied as ULF value(s) 462 generated by ULF component 460. As an example, ULF component 460 can employ the formula

L_{new}(xⱼ)=(1−p_{uncert})*L_{old}(xⱼ)+p_{uncert}*C_{penalty},

where L_{old}(xⱼ) is conventional loss function data, e.g., CLF data from CLF component 450, where p_{uncert} is uncertainty information embodied in UPS 440, where C_{penalty} is a penalty value that can be accessed from penalty value(s) 472 generated by penalty value component (PVC) 470, and where L_{new}(xⱼ) is uncertainty based loss data derived from CLF data. As such, conventional loss functions can again be employed in the presently disclosed subject matter, e.g., via CLF component 450, etc., and resulting CLF data can be employed in determining ULF value(s) 462. ULF value(s) 462 can therefore include uncertainty information in resulting loss data vectors that can indicate uncertainties for outputs of UL output(s) 430. Accordingly, outputs corresponding to loss values transitioning a threshold level can be segregated from other outputs of ML output(s) 430. Segregated portions of ML output(s) 430 can then be subject to further actions that can, in embodiments, be distinct from other portions of ML output(s) 430.

In embodiments, ML responding component 412 can receive ML output(s) 430 and ULF value(s) 462. This can allow ML responding component 412 to respond to portions of ML output(s) 430 based on ULF value(s) 462. Again similar to the example presented in system 200, where ML component 410 is trained on images of fish, an input of a kangaroo can result in MLUC 411 generating UPS 440 indicating that there is uncertainty corresponding to an output related to the kangaroo image input, e.g., because the kangaroo image can differ substantively from the fish training images, ML component 410 can ‘have less confidence that an out based on the kangaroo image will be accurate’. This information can be passed to ULF component 460 via UPS 440, which can result in ULF value(s) 462 designating an output of ML output(s) 430 corresponding to the kangaroo image input as having a lower level of confidence, e.g., segregating said corresponding output as ‘more uncertain’ than some other outputs of ML output(s) 430. ML responding component 412 can then take an action based on the segregation of the kangaroo-image-based output, for example, sending that output to a human expert, etc. This example can illustrate that ML input(s) 420 can be employed, e.g., via MLUC 411, etc., to determine an associated uncertainty inherent in the corresponding output. In some embodiments, ML component 410 can entirely avoid generating an output for inputs having sufficient uncertainty determined by MLUC 411, e.g., a lack of a predictive output, e.g., a non-output, etc., can itself be regarded as an output comprised in MP output(s) 430. However, the use of penalty value(s) 472 can cause ML component 410 to generate predictions via ML output(s) 430 even where the corresponding output can be moderately uncertain, e.g., in accord with the previously mentioned poker analogy, ML component 410 can ‘fold’ where the hand, e.g., input(s), are determined to not be good enough to likely win the game, e.g., the corresponding output will transition an uncertainty threshold. Again, in this analogy, ‘folding’ can be predicted where p_{uncert} is approaches a threshold uncertainty value, which can result in ML component 410 generating ML output(s) 430 with about an average loss for a corresponding conventional ML system. However, generating outputs for ‘good inputs’ and ‘folding’ for the rest can again, in practice, result in a ‘reluctant’ ML component 410, e.g., ML component 410 can fold too often to be practicable in an attempt to avoid generating outputs for inputs corresponding to almost any level of uncertainty. This can be akin to a poker player only playing the very best hands and folding on all other hands, resulting in very few hands actually being played. As such, penalty value(s) 472 comprising C_{penalty}, much like an ante in the game of poker, can result in ML component 410 generating outputs for more ML input(s) 420 than without the penalty value, in accord with the example illustrative formula. The presently disclosed penalty value can again act much like the poker ante and can cause ML component 410 to predict an output based on inputs corresponding to greater uncertainty than without use of C_{penalty}. Additionally, where the uncertainty is sufficiently great, then ML component 410 can elect to avoid generating a prediction.

PVC 470 can again receive penalty parameters(s) 474 and can determine penalty value(s) based on penalty parameter(s) 474, ULF value(s) 462, or combinations thereof. As an example, penalty parameter(s) 474 can comprise an initial penalty value, such as an arbitrarily high initial penalty value that can employed to allow PVC 470 to converge on a subsequent penalty value, such as when training ML component 410 comprising MLUC 411. Additionally, PVC 470 can receive step parameter(s) 478, which can indicate an interval of change to the penalty value. In this regard, where the initial penalty value is set extremely high, ML component 410 can favor generating predictive outputs for almost all inputs to avoid the penalty, e.g., the new loss function can have a loss value vector dominated by the penalty value and avoiding generation of outputs, even those with higher uncertainties, need not occur. However, using a high initial penalty value to ‘force’ ML component 410 into generating outputs is not a desirable continuous state, e.g., in the poker game analogy, while playing nearly no hands is undesirable, so is playing all hands and ignoring the probability that a hand will lose. As such, the penalty value can be adapted, for example, according to the formula:

C_{penalty}=mean(L_{old}(x_{batch}_{ⱼ})),

where L_{old} (x_{batch}_{ⱼ}) is the average loss according to CLF component 450. It is noted that C_{penalty} can be kept above a floor value to avoid cases where the penalty value goes to zero and the incentive to generate predictive outputs for all but the lowest uncertainties reoccurs, e.g., the penalty value from the above formula can be subject to a further rule such as C_{penalty}=max(C_{penalty}, Cₘᵢₙ), where Cₘᵢₙ is selectable and is treated as a minimum permitted penalty value permitted. The uncertainty, once stabilized based on the above formula, can then be adjusted incrementally based on step parameter(s) 478. This can allow adjustment of the penalty value where it has settled, according to the above formula, at a penalty value that is lower/higher than desired.

Incrementing or decrementing a stable penalty value can be based on step parameter(s) 478. Step parameter(s) 478 can indicate a preferred loss value and an increment value. Increment/decrement component 476 can be comprised in PVC 470 and can, once the penalty value has stabilized according to the above formula, can determine if the mean uncertainty, e.g., from UPS 440, is greater or lower than expected, and can then incrementally adjust the penalty value to cause ML component 410 to be more aggressive, e.g., generating predictions for more uncertain cases, or less aggressive, e.g., generating predictions for less uncertain cases. Where mean(p_{uncert}) is less than a selected value, e.g., a preferred loss value that can be embodied in step parameter(s) 478, then C_{penalty}=C_{penalty}−∈, and where mean(p_{uncert}) is more than the selected value, C_{penalty}=C_{penalty}+∈, where ∈ is an incremental value that can be embodied in step parameter(s) 478. In some embodiments, the incremental value can be a small number, for example, 0.01, 0.1, etc.

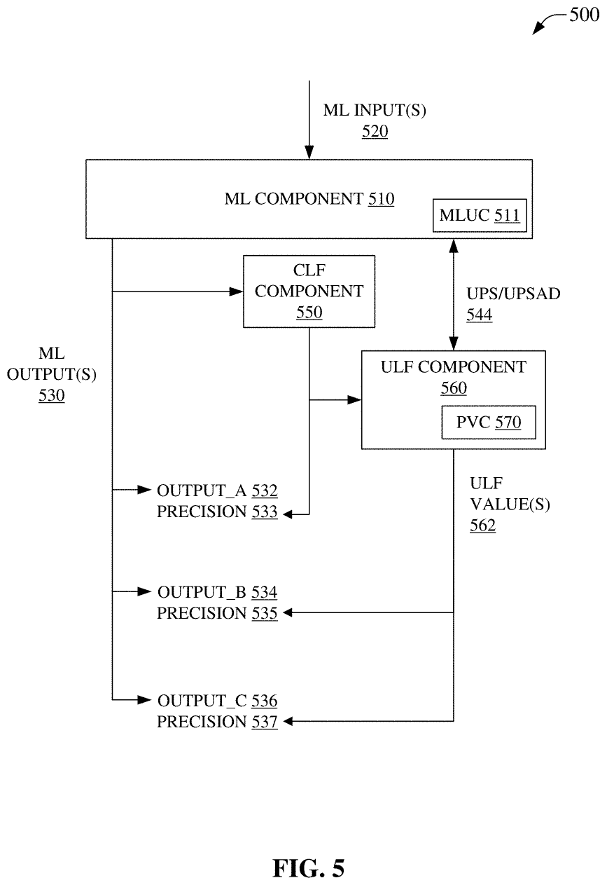

FIG. 5 is an illustration of a system 500, which can facilitate generating, via a novel loss function, loss values corresponding to uncertainty probabilities, wherein the loss values enable segregation of machine learning outputs, in accordance with embodiments of the subject disclosure. System 500 can comprise ML component 510, which can comprise MLUC 511, and can generate ML output(s) 530 based on ML input(s) 520. MLUC 511 can generate uncertainty probabilities, e.g., p_{uncert}, etc., based on ML input(s) 520 that can correspond to outputs of ML output(s) 530. The uncertainties can be comprised in UPS/UPSAD 544. UPS/UPSAD 544 can also be employed to update ML component 510, a corresponding ML model employed by ML component 510, MLUC 511, etc., e.g., to adjust ML output(s) 530, the determination of uncertainty probabilities, etc., as disclosed elsewhere herein.

ULF component 560 can comprise PVC 570 and can generate ULF value(s) 562. PVC 570 can function to adjust penalty values, e.g., C_{penalty}, employed in a loss function, for example, in L_{new}(xⱼ)=(1−p_{uncert})*L_{old}(xⱼ)+p_{uncert}*C_{penalty}, as disclosed elsewhere herein. L_{old}(xⱼ) can be received via CLF component 550. L_{new}(xⱼ) can be embodied in ULF value(s) 562. This can support segregation of outputs from ML component 510.

In the illustrated example embodiment, ML output(s) 530 can comprise Output_A 532, Output_B 534, Output_C 536, etc. In an example, Output_A 532 can be all outputs, while Output_B 534 can be a first portion of Output_A 532, and Output_C 536 can be a second portion of Output_A 532, e.g., ‘A’ comprises ‘B’ and ‘C’. In this regard, while Output_B 534 and Output_C 536 can be considered different segregations of outputs comprised in Output_A 532. As illustrated, Output_A 532 can correspond to a conventional loss function applied at CLF component 550 indicating Precision 533. In contrast, Output_B 534 and Output_C 536 can correspond to other losses from the presently disclosed new loss function, e.g., L_{new}(xⱼ), resulting in Output_B 534 having precision 535 and Output_C 536 having precision 537. As an example, precision 533 can be 0.433, while precision 535 can be 0.275 and precision 537 can be 0.649, such as were measured in testing of the disclosed subject matter. Where Output_A 532 has a precision of 0.433, nearly 60% of the outputs can be ‘wrong’ and reliance on those outputs can be challenging for a business employing an example ML system. In the previously discussed call center example, this conventional ML output would route nearly 2 of every three calls to a wrong customer service representative. In contrast, segregation of the outputs via application of the disclosed new loss function and uncertainty probabilities can result in the outputs of Output_C 536 being nearly 65% accurate, e.g., nearly 65 of every 100 calls can be routed to a correct customer service representative, a great improvement over Output_A 532. Moreover, Output_B 534 can be segregated by the disclosed subject matter, such that the low precision outputs can be routed for other action, for example to human experts. As such, Output_B 534 having only 25.5% precision can result in most of the routes to human experts truly needing a human expert to take further action, e.g., nearly 7 of every 10 calls routed to an example human expert would have been routed to the wrong customer service representative if they had not been segregated for further action. Accordingly, with the presently disclosed subject matter in the call center example, more calls can be properly routed to begin with, e.g., Output_C 536, and of those calls segregated out, e.g., Output_B 534, many of those calls truly would not have otherwise been properly routed and it is appropriate to have routed them to example human experts. These positive results can be sharply contrasted with conventional ML systems that, in the same example, would mis-route most calls, leading to frustration, increased cost, etc., and still needing eventual re-routing to a human expert for further action, except that this re-routing to a human expert would occur after many of the example calls were mis-routed to begin with.

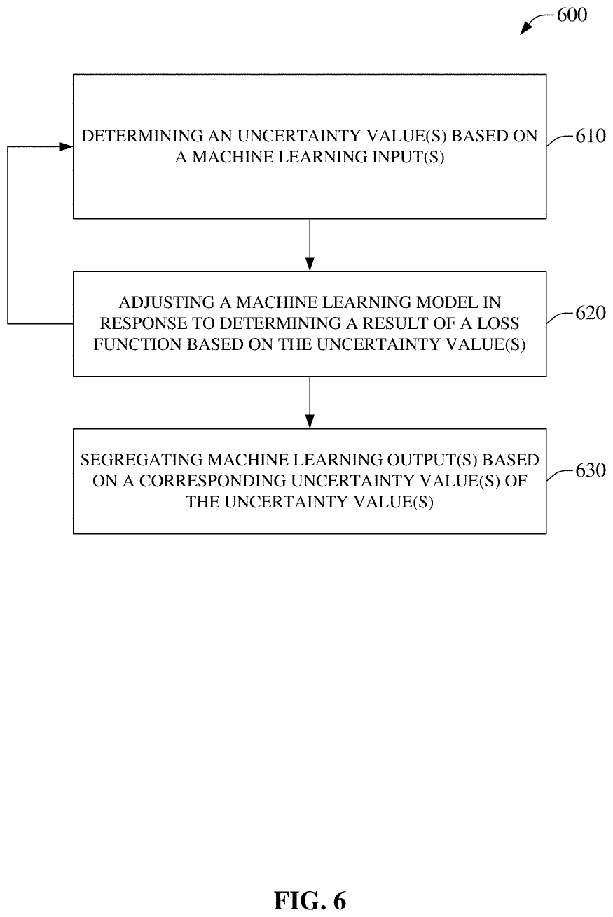

In view of the example system(s) described above, example method(s) that can be implemented in accordance with the disclosed subject matter can be better appreciated with reference to flowcharts in FIG. 6-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternately be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more embodiments herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 6 is an illustration of an example method 600, which can facilitate generating a machine learning output uncertainty probability based on machine learning inputs, in accordance with embodiments of the subject disclosure. At 610, method 600 can comprise determining an uncertainty value(s) based on a machine learning (ML) input(s) to an ML system. Conventional ML systems typically do not determine, based on ML inputs, an uncertainty that the ML system will accurately determine a corresponding ML output. The new additional output class disclosed herein, e.g., the uncertainty value(s) based on the ML input(s), can indicate a level of confidence that a corresponding ML output will be accurate. In the previously discussed poker analogy, a player can surmise how likely a hand dealt to them will be to win the round of poker based on the cards they were dealt and their previous experience playing poker. Similarly, a ML system can determine the uncertainty value(s) to predict how likely the ML system will be at generating an accurate ML output(s) based on the ML input(s) received.

Method 600, at 620, can comprise adjusting a machine learning model employed by a ML system in response to determining a result of a loss function. The result of the loss function can be based on the uncertainty value(s) determined at 610. As an example, a loss function can be L_{new}(xⱼ)=(1−p_{uncert})*L_{old}(xⱼ)+p_{uncert}*C_{penalty}, as disclosed elsewhere herein, wherein p_{uncert} can be the uncertainty value(s) determined at 610. It is noted that use of loss values from a conventional loss function, e.g., L_{old}(xⱼ), can be employed to enable use of the presently disclosed loss function, e.g., L_{new}(Xⱼ), with existing conventional loss functions, e.g., the presently disclosed loss function can leverage existing conventional loss functions to generate new loss vectors that are considerate of the uncertainty value(s) determined from inputs to an ML system. Method 600 can then return to 610, for example in a training mode, to determine subsequent uncertainty value(s) based on an updated ML model employed by an ML system. This can result in the ML system converging on a ML model that can seek to minimize the losses embodied in the results of the presently disclosed loss function, e.g., the disclosed loss function can be employed to improve the ML model so that there are reduced losses, e.g., less inaccurate ML outputs from the ML system.

At 630, machine learning output(s) can be segregated based on a corresponding uncertainty value(s) comprised in the uncertainty value(s). At this point, method 600 can end. Where ML input(s) result in an uncertainty value(s) transitioning a threshold value(s), the corresponding ML output(s) can be treated differently than other ML output(s) corresponding to uncertainty value(s) that do not transition the threshold value(s). As an example, ML inputs that are substantially different from inputs used to train an ML system can result in ML outputs that have a low confidence of being accurate, e.g., the ML inputs can result in high uncertainty value(s). In this example, the outputs corresponding to the high uncertainty value(s) can be subject to further actions, such as being passed to a human expert for further action, in contrast to other outputs that can correspond to ML inputs that have lower uncertainty value(s) and thus have a higher confidence of being accurate ML outputs, which other ML outputs, for example, can be used without being passed to a human expert. In embodiments, this can result in a first portion of ML outputs being considered as sufficiently accurate, e.g., the corresponding uncertainty value(s) do not transition a threshold value(s), and a second portion of the ML outputs being considered as insufficiently accurate, e.g., the corresponding uncertainty value(s) do transition the threshold value(s). In these embodiments, the first portion can be treated differently than the second portion. This can be of benefit to a user of a ML system in accord with the instant disclosure, for example, the first portion can have fewer inaccurate predictions and can therefore avoid costs, time, difficulty associated with managing predictions that intrinsically comprise more inaccurate predictions. Moreover, the second portion can have more inaccurate predictions and can also save time, cost, difficulty, for example where the second portion is routed to a human expert, the second portion can have a higher proportion of ML outputs that actually needed the human expert's attention, e.g., the example human expert can review a lower percentage of outputs that did not actually need the human expert to review them.

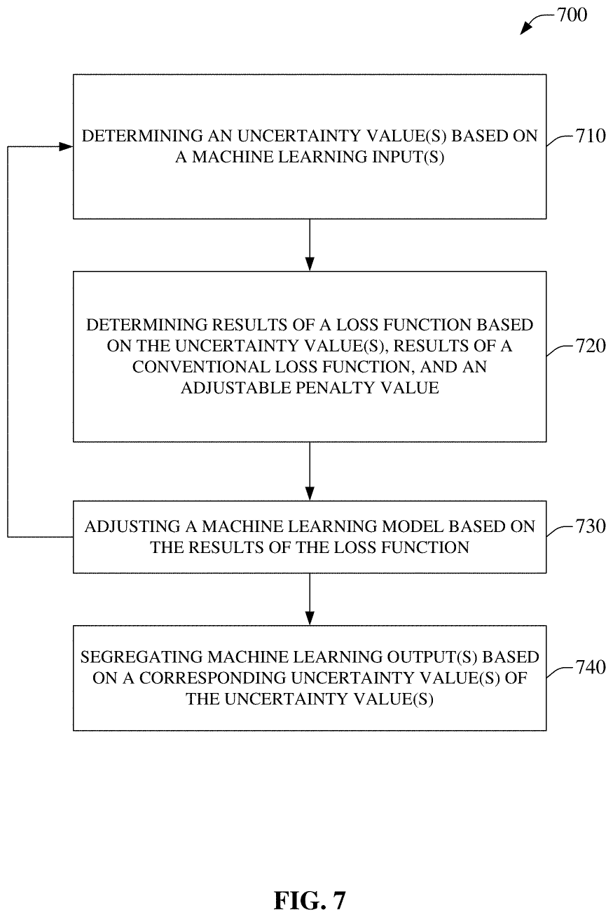

FIG. 7 is an illustration of an example method 700, which can facilitate generating a machine learning output uncertainty probability based on machine learning inputs and an adjustable penalty value, in accordance with embodiments of the subject disclosure. At 710, method 700 can comprise determining an uncertainty value(s) based on a ML input(s) to an ML system. An output class can be added in relation to the uncertainty value(s), as disclosed elsewhere herein. The uncertainty value(s) based on the ML input(s), can reflect a level of confidence that a corresponding ML output will be accurate. An ML system can determine the uncertainty value(s) to predict how likely the ML system will be at generating an accurate ML output(s) based on the ML input(s) received, much like a poker player can evaluate a hand of cards dealt to them in regard to how likely that hand of cards is to win the round of poker.

Method 700, at 720, can comprise determining a result of a loss function based on the uncertainty value(s), results of a conventional loss function, and an adjustable penalty value, for example, via the presently disclosed loss function L_{new}(xⱼ)=(1−p_{uncert})*L_{old}(xⱼ)+p_{uncert}*C_{penalty}, as disclosed elsewhere herein, wherein p_{uncert} can be the uncertainty value(s) determined at 710, L_{old}(xⱼ) is the results of a conventional loss function, and C_{penalty} is the adjustable penalty value. As such, the presently disclosed loss function, e.g., L_{new}(xⱼ) can be derived, in part, from loss values from a conventional loss function, e.g., L_{old}(xⱼ). Accordingly, known conventional loss functions can be employed to generate new loss vectors, e.g., via L_{new}(xⱼ), that are considerate of the uncertainty value(s) determined from inputs to an ML system.

Training of a ML system to better optimize L_{new}(xⱼ) can be improved by inclusion of the adjustable penalty value, e.g., C_{penalty}. Without a penalty value, optimization of the disclosed loss function can result in an ML system generating predictions comprised in ML output(s) for ML inputs corresponding to high levels of confidence, e.g., low uncertainty value(s). In the poker analogy, where a player doesn't have to buy into a hand of poker, the player will simply fold unless there is a very high probability of winning the hand. In the disclosed subject matter, causing the ML system to be overly risk averse can result in many more cases being ‘folded’ and, for example, being passed on for further action. The adjustable penalty value can then be updated to alter the resulting output of the loss function and therefore can be reflected in updates to a ML model and therefore in subsequent determinations of uncertainty value(s).

Typical adjustment of the penalty to not determining an output can occur contemporaneously with adaptations to an ML model employed by an ML system, e.g., at 730, method 700 can comprise adjusting a ML model based on the results of the loss function, e.g., L_{new}(xⱼ), including the adjustable penalty value, to a point where a steady gradient feedback to the new class of uncertainty value(s) is maintained, e.g., the loss vectors from the presently disclosed loss function can stabilize based on the uncertainty values and the adjustable penalty value. Method 700 can then return to 710 from 730, for example in a training mode, to again determine subsequent uncertainty value(s) based on an updated ML model employed by an ML system, where the loss function has contemporaneously been updated. This can result in the ML system converging on a ML model that can seek to minimize the losses embodied in the results of the presently disclosed loss function subject to the adjustable penalty value(s).

At 740, machine learning output(s) can be segregated based on a corresponding uncertainty value(s) comprised in the uncertainty value(s). At this point, method 700 can end. As before, where ML input(s) result in an uncertainty value(s) transitioning a threshold value(s), the corresponding ML output(s) can be treated differently than other ML output(s) corresponding to uncertainty value(s) that do not transition the threshold value(s). In embodiments, this can result in a first portion of ML outputs being considered as sufficiently accurate, e.g., the corresponding uncertainty value(s) do not transition a threshold value(s), and a second portion of the ML outputs being considered as insufficiently accurate, e.g., the corresponding uncertainty value(s) do transition the threshold value(s). In these embodiments, the first portion can be treated differently than the second portion. This can be of benefit to a user of a ML system in accord with the instant disclosure, for example, the first portion can have fewer inaccurate predictions and can therefore avoid costs, time, difficulty associated with managing predictions that intrinsically comprise more inaccurate predictions. Moreover, the second portion can have relatively more inaccurate predictions and can also save time, cost, difficulty, for example where the second portion is routed to a human expert, the second portion can have a higher proportion of ML outputs that actually needed the human expert's attention.

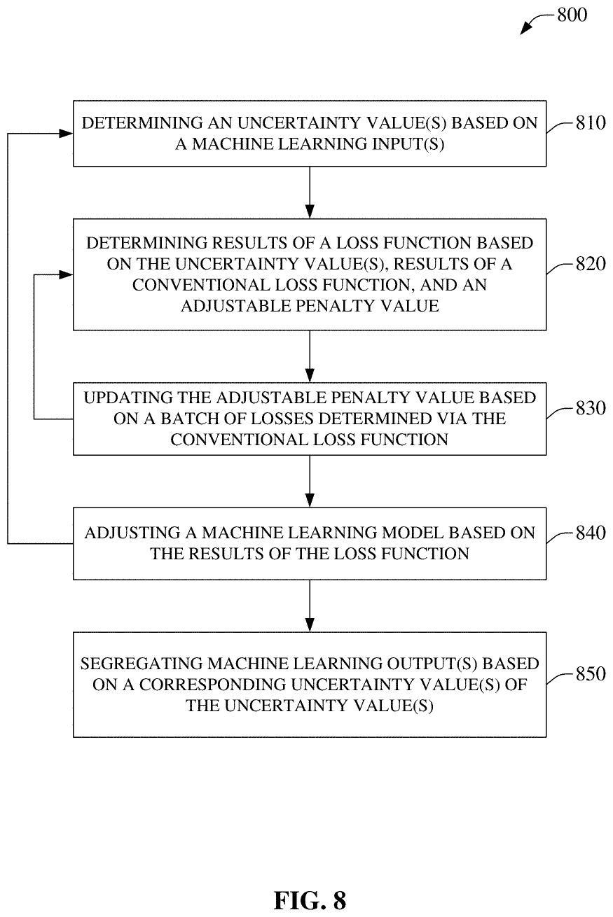

FIG. 8 is an illustration of an example method 800, which can facilitate generating a machine learning output uncertainty probability based on machine learning inputs and an adjustable penalty value, wherein the adjustable penalty value is updateable based on batched losses of a loss function, in accordance with embodiments of the subject disclosure. At 810, method 800 can comprise determining an uncertainty value(s) based on a ML input(s) to an ML system. An output class can be added in relation to the uncertainty value(s), as disclosed elsewhere herein. The uncertainty value(s) based on the ML input(s), can reflect a level of confidence that a corresponding ML output will be accurate. An ML system can determine the uncertainty value(s) to predict how likely the ML system will be at generating an accurate ML output(s) based on the ML input(s) received, much like a poker player can evaluate a hand of cards dealt to them in regard to how likely that hand of cards is to win the round of poker.

Method 800, at 820, can comprise determining a result of a loss function based on the uncertainty value(s), results of a conventional loss function, and an adjustable penalty value, for example, via the presently disclosed loss function L_{new}(xⱼ)=(1−p_{uncert})*L_{old}(xⱼ)+p_{uncert}*C_{penalty}, as disclosed elsewhere herein, wherein p_{uncert} can be the uncertainty value(s) determined at 810, L_{old}(xⱼ) is the results of a conventional loss function, and C_{penalty} is the adjustable penalty value. As such, the presently disclosed loss function, e.g., L_{new}(xⱼ) can be derived, in part, from loss values from a conventional loss function, e.g., L_{old}(xⱼ). Accordingly, known conventional loss functions can be employed to generate new loss vectors, e.g., via L_{new}(xⱼ), that are considerate of the uncertainty value(s) determined from inputs to an ML system.

As before, training of a ML system to better optimize L_{new}(xⱼ) can be improved by inclusion of the adjustable penalty value, e.g., C_{penalty}. Without a penalty value, optimization of the disclosed loss function can result in an ML system being overly conservative and generating predictions comprised in ML output(s) for ML inputs corresponding to high levels of confidence, e.g., low uncertainty value(s). An ML system that is overly conservative can result in many more cases being ‘folded’ and, for example, being passed on for further action. Accordingly, inclusion of a penalty value can act similar to an ante in a hand of poker and the adjustable penalty value can be initially very high, for example during training of the ML system, to encourage the ML system to generate outputs even with elevated losses, e.g., greater levels of inaccuracy in the results.

At 830, the adjustable penalty value of method 800 can then be updated to reflect the inaccuracy of a previous round of output/training. As an example, C_{penalty}=max(C_{penalty}, Cₘᵢₙ), where C_{penalty}=mean(L_{old}(x_{batch_j})) e.g., the adjustable penalty can be determined from results of a conventional loss function for a batch of inputs, mean(L_{old}(x_{batch_j}), while being kept above a floor value, Cₘᵢₙ. Method 800, at 830, can then return to 820 for another iteration to further refine the adjustable penalty value, which can typically result in downward adjustment of the penalty of not determining an output. As before, this can happen contemporaneously with any adaptations to an ML model employed by an ML system, e.g., the loop from 840 to 810, wherein method 800 can also comprise adjusting a ML model based on the results of the loss function, e.g., L_{new}(xⱼ), to a point where a steady gradient feedback to this new class is maintained, e.g., the loss vectors from the presently disclosed loss function can stabilize as can the adjustable penalty value. In an example of updating the adjustable penalty value, the adjustable penalty value can be set at an initially high penalty, the ML system will therefore favor attempting to generate output predictions for almost all inputs and can result in elevated losses resulting for the disclosed loss function, e.g., the outputs will contain more inaccuracies because the ML system is not ‘folding on any inputs’ to avoid the initially very high penalty value. Typically, the high penalty value can cause an ML system to generate ML outputs with similar accuracies to conventional ML systems because, like conventional systems, the high penalty value causes the ML system to generate predictions for all, or nearly all, input cases with little regard for the uncertainty values dues to the adjustable penalty value dominating the presently disclosed loss function in the example initial state.

After a first round of results, in this example, the initial penalty value can be updated, for example, to the mean value of a conventional loss function for the outputs of the first round, which typically can be less than the elevated value of the initial penalty value. A second round can be performed with this updated penalty value, e.g., looping from 830 to 820, looping from 840 to 810, or some combination thereof, because in some embodiments the ML model can also have been contemporaneously updated between the example first and second rounds. Where, in this example, the penalty value in the second round is lower, the ML system can therefore be more conservative and generate predictions for inputs having correspondingly lower uncertainty value(s). This can result in a first portion of the outputs having a greater accuracy, and a second portion being relegated to further actions, e.g., human experts, etc. After the second round, the results of the conventional loss function applied to the first portion second round outputs can be again used to refine the adjustable penalty value, e.g., further iterations from 830 to 820 and/or further iterations from 840 to 810. This example can be extended to a point where L_{new}(xⱼ) is better optimized that it would have been where a penalty value was not introduced, e.g., the ML system can be less conservative than where there is no penalty for ‘folding’ but can be more conservative that where the uncertainty values are not determined at all, e.g., as in conventional ML systems.

As in system 700, method 800 can return from 840 to 810, as noted hereinabove, to determine subsequent uncertainty value(s) based on an updated ML model employed by an ML system, where the loss function has been updated, for example, based on refinement of the adjustable penalty value, or the uncertainty value(s), etc., of the presently disclosed loss function. This can result in the ML system converging on a ML model that can seek to minimize the losses embodied in the results of the presently disclosed loss function subject to the adjustable penalty value(s).

At 840, machine learning output(s) can be segregated based on a corresponding uncertainty value(s) comprised in the uncertainty value(s). At this point, method 800 can end. As before, where ML input(s) result in an uncertainty value(s) transitioning a threshold value(s), the corresponding ML output(s) can be treated differently than other ML output(s) corresponding to uncertainty value(s) that do not transition the threshold value(s). In embodiments, this can result in a first portion of ML outputs being considered as sufficiently accurate, e.g., the corresponding uncertainty value(s) do not transition a threshold value(s), and a second portion of the ML outputs being considered as insufficiently accurate, e.g., the corresponding uncertainty value(s) do transition the threshold value(s). In these embodiments, the first portion can be treated differently than the second portion. This can be of benefit to a user of a ML system in accord with the instant disclosure, for example, the first portion can have fewer inaccurate predictions and can therefore avoid costs, time, difficulty associated with managing predictions that intrinsically comprise more inaccurate predictions. Moreover, the second portion can have relatively more inaccurate predictions and can also save time, cost, difficulty, for example where the second portion is routed to a human expert, the second portion can have a higher proportion of ML outputs that actually needed the human expert's attention.

It is noted that in some embodiments, where the presently disclosed loss function does not settle in a manner that meets a selectable criteria, for example, where the new loss function is still too conservative, not conservative enough, etc., for a selectable business goal defined by an entity employing a ML system in accord with the instant disclosure, then the adjustable penalty constant can be further adapted via an additional process. As an example, where an indicator value based on the uncertainty value(s) is less than a target value, the penalty value can be incrementally decreased, while where the indicator value is more than the target value, the penalty value can be incrementally increased. This increment/decrement process can be looped to allow the indicator value to converge on the target value. As an example, if a call center wants to automatically route up to 30% of incoming calls to human experts, e.g., the target value is up to 30%, and where the ML system is stable and automatically routing 32% of calls to human experts, e.g., the indicator value is 32%, then the adjustable penalty value can be incrementally adjusted to a lower value to cause the ML system to be less conservative and to automatically route fewer calls for further action, e.g., fewer calls can be automatically routed to the human experts where there is less penalty for the ML generating an output. In some embodiments, the indicator value can be mean(p_{uncert}), such that C_{penalty}=C_{penalty}−∈ when the target value is greater than the mean(p_{uncert}), and C_{penalty}=C_{penalty}+∈, when the target value is less than the mean(P_{uncert}), where ∈ is a selectable, typically small, incremental value, for example 0.001, 0.01, 0.1, etc. It is noted that the smaller ∈, the more iterations it can take for the indicator value to converge on the target value, while the larger the ∈, the less likely the indicator and target values will actually match. In some embodiments, ∈ can be dynamically adjusted so that early iterations rapidly converge based on initially larger ∈ values, and later iterations, via smaller E values are able to approach convergence of the indicator and target values.

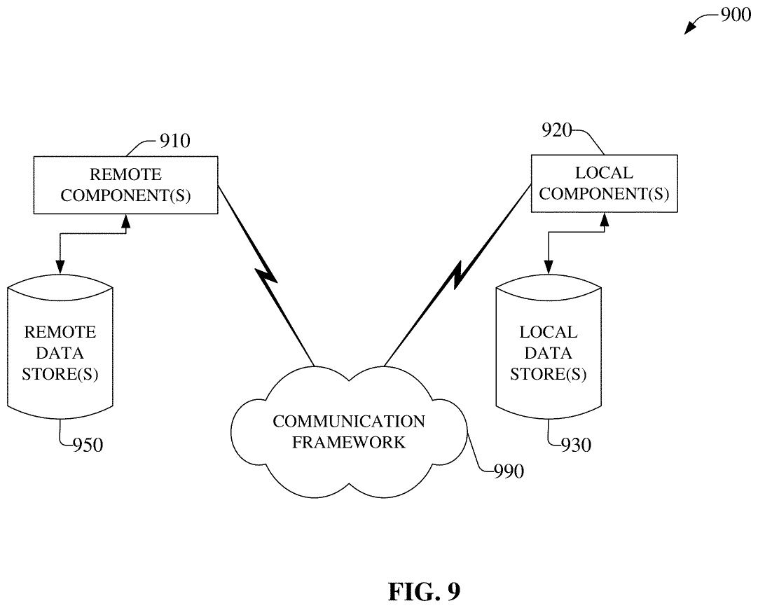

FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a remotely located device comprised in ML component 110-510, etc., CLF component 150-550, etc., ML responding component 112-412, etc., ULF component 260-560, etc., PVC 370-570, MLUC 111-511, etc., or other remotely located components connected to a local component via communication framework(s) 990, etc. Communication framework 990 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices). In some embodiments, local component(s) 920 can comprise a local device comprised in ML component 110-510, etc., CLF component 150-550, etc., ML responding component 112-412, etc., ULF component 260-560, etc., PVC 370-570, MLUC 111-511, etc., or other locally located components.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 990 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 990. Similarly, local component(s) 920 can be operably connected to one or more local data store(s) 930, that can be employed to store information on the local component(s) 920 side of communication framework 990. As examples, UPS 140-440, etc., UPSAD 242-442, UPS/UPSAD 544, etc., ULF values(s) 262-562, etc., ML input(s) 120-520, etc., ML output(s) 130-530, etc., or other information can be communicated from a remotely located component, via communication framework(s) 990, etc., to a local component to facilitate the presently disclosed subject matter.

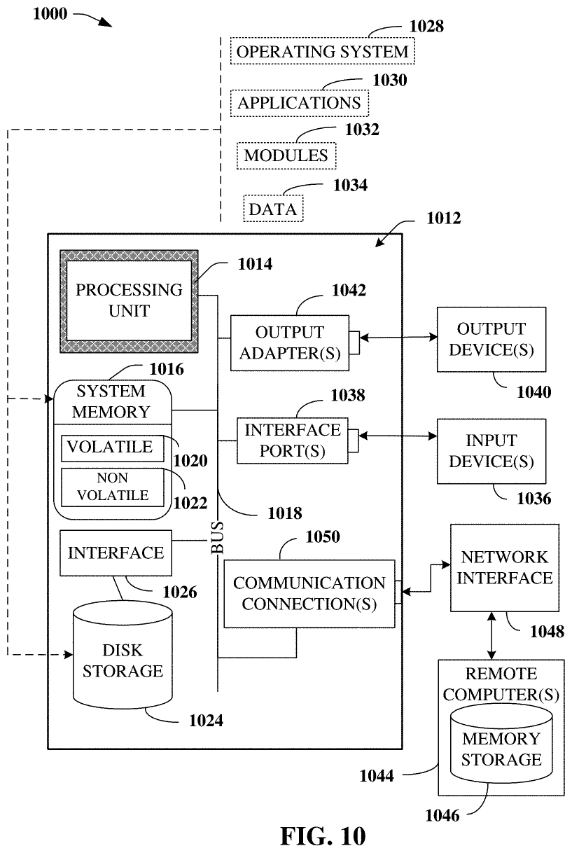

In order to provide a context for the various embodiments of the disclosed subject matter, FIG. 10, and the following discussion, are intended to provide a brief, general description of a suitable environment in which the various embodiments of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can comprise both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random-access memory, synchronous dynamic random-access memory, double data rate synchronous dynamic random-access memory, enhanced synchronous dynamic random-access memory, SynchLink dynamic random-access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, comprised in any of ML component 110-510, etc., CLF component 150-550, etc., ML responding component 112-412, etc., ULF component 260-560, etc., PVC 370-570, MLUC 111-511, etc., or other components disclosed herein, can comprise a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can comprise volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can comprise read only memory, programmable read only memory, electrically programmable read only memory, electrically erasable read only memory, or flash memory. Volatile memory 1020 comprises read only memory, which acts as external cache memory. By way of illustration and not limitation, read only memory is available in many forms such as synchronous random-access memory, dynamic read only memory, synchronous dynamic read only memory, double data rate synchronous dynamic read only memory, enhanced synchronous dynamic read only memory, SynchLink dynamic read only memory, Rambus direct read only memory, direct Rambus dynamic read only memory, and Rambus dynamic read only memory.

Computer 1012 can also comprise removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, flash memory card, or memory stick. In addition, disk storage 1024 can comprise storage media separately or in combination with other storage media comprising, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically comprise a variety of media, which can comprise computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can comprise non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium. As such, for example, a computer-readable medium can comprise executable instructions stored thereon that, in response to execution, can cause a system comprising a processor to perform operations comprising determining an uncertainty value based on inputs to a machine learning system, wherein the uncertainty value corresponds to an output of the machine learning system. A penalty value of a loss function can be iteratively updated and updates to the penalty value can be based on previous results of a conventional loss function. Moreover, a machine learning model employed by the machine learning system can be iteratively adapted based on the uncertainty value. In the example, the output of the machine learning system can be correlated with the uncertainty value to enable segregation of outputs of the machine learning system into at least first outputs comprising the output correlated to the uncertainty value and second outputs not comprising the output correlated to the uncertainty value.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. In some embodiments, a user interface can allow entry of user preference information, etc., and can be embodied in a touch sensitive display panel, a mouse/pointer input to a graphical user interface (GUI), a command line-controlled interface, etc., allowing a user to interact with computer 1012. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 comprise, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial bus port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 comprise, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, a cloud service, code executing in a cloud-computing environment, a workstation, a microprocessor-based appliance, a peer device, or other common network node and the like, and typically comprises many or all of the elements described relative to computer 1012. A cloud computing environment, the cloud, or other similar terms can refer to computing that can share processing resources and data to one or more computer and/or other device(s) on an as needed basis to enable access to a shared pool of configurable computing resources that can be provisioned and released readily. Cloud computing and storage solutions can store and/or process data in third-party data centers which can leverage an economy of scale and can view accessing computing resources via a cloud service in a manner similar to a subscribing to an electric utility to access electrical energy, a telephone utility to access telephonic services, etc.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies comprise fiber distributed data interface, copper distributed data interface, Ethernet, Token Ring and the like. Wide area network technologies comprise, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and digital subscriber line modems, integrated services digital network adapters, and Ethernet cards.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. Moreover, the use of any particular embodiment or example in the present disclosure should not be treated as exclusive of any other particular embodiment or example, unless expressly indicated as such, e.g., a first embodiment that has aspect A and a second embodiment that has aspect B does not preclude a third embodiment that has aspect A and aspect B. The use of granular examples and embodiments is intended to simplify understanding of certain features, aspects, etc., of the disclosed subject matter and is not intended to limit the disclosure to said granular instances of the disclosed subject matter or to illustrate that combinations of embodiments of the disclosed subject matter were not contemplated at the time of actual or constructive reduction to practice.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities, machine learning components, or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, extremely high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; second generation partnership project (2G or 2GPP); third generation partnership project (3G or 3GPP); fourth generation partnership project (4G or 4GPP); long term evolution (LTE); fifth generation partnership project (5G or 5GPP); sixth generation partnership project (6G or 6GPP); other advanced mobile network technologies, third generation partnership project universal mobile telecommunications system; third generation partnership project 2; ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced. As an example, a millimeter wave broadcast technology can employ electromagnetic waves in the frequency spectrum from about 30 GHz to about 300 GHz. These millimeter waves can be generally situated between microwaves (from about 1 GHz to about 30 GHz) and infrared (IR) waves, and are sometimes referred to extremely high frequency (EHF). The wavelength (λ) for millimeter waves is typically in the 1-mm to 10-mm range.

The term “infer,” or “inference,” can generally refer to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference, for example, can be employed to identify a specific context or action, or can generate a probability distribution over states of interest based on a consideration of data and events. Inference can also refer to techniques employed for composing higher-level events from a set of events and/or data. Such inference results in the construction of new events or actions from a set of observed events and/or stored event data, whether the events, in some instances, can be correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A device, comprising:
a processor; and
a memory that stores executable instructions that, when executed by the processor, facilitate performance of operations, comprising:
determining, based on inputs to a machine learning system, an uncertainty value corresponding to an output of the machine learning system;
updating a machine learning model employed by the machine learning system based on the uncertainty value; and
segregating outputs of the machine learning system into a first portion of the outputs comprising the output and a second portion of the outputs based on the uncertainty value.

2. The device of claim 1, wherein the machine learning system employs a conventional loss function, and wherein the machine learning model is updated based on a loss function determining a loss vector based on results of the conventional loss function and the uncertainty value.

3. The device of claim 2, wherein the loss function further comprises an adjustable penalty value.

4. The device of claim 3, wherein the loss function is L_{new}(xⱼ)=(1−p_{uncert})*L_{old}(xⱼ)+p_{uncert}*C_{penalty}, wherein p_{uncert} is the uncertainty value, wherein L_{old}(xⱼ) are the results of the conventional loss function, and wherein C_{penalty} is the adjustable penalty value.

5. The device of claim 3, wherein the adjustable loss value, in a first iteration of evaluating the loss function, is initially set to at least a defined value, resulting in the adjustable loss value term initially dominating the loss function.

6. The device of claim 5, wherein the defined value is at least 100.

7. The device of claim 3, wherein the adjustable loss value, in a second iteration of evaluating the loss function, is updated from an initial value to a subsequent value based on first results of the results of the conventional loss function from a first iteration of evaluating the loss function.

8. The device of claim 7, wherein the subsequent value results from a mean value of the first results of the conventional loss function from the first iteration of evaluating the loss function.

9. The device of claim 8, wherein the subsequent value is restricted from traversing a floor penalty value.

10. The device of claim 3, wherein the adjustable loss value is iteratively updated based on a hyperparameter to cause an indicator value to converge to a target value across iterations of evaluating the loss function, wherein the indicator value is based on a mean of uncertainty values comprising a respective uncertainty value in each iteration of the evaluating the loss function, wherein the target value is selectable based on user input received via a user interface, and wherein the hyperparameter is less than 1.

11. A method, comprising:
determining, by a system comprising a processor, an uncertainty value, based on inputs to a machine learning system, wherein the uncertainty value corresponds to an output of the machine learning system;
updating, by the system, a penalty value of a loss function based on first results of a conventional loss function;
adapting, by the system, a machine learning model employed by the machine learning system based on the uncertainty value; and
correlating, by the system, the output of the machine learning system with the uncertainty value.

12. The method of claim 11, wherein the updating the penalty value and the adapting the machine learning model increase an efficacy of the loss function according to a defined performance criterion, wherein the loss function is L_{new}(xⱼ)=(1−p_{uncert})*L_{old}(xⱼ)+p_{uncert}*C_{penalty}, wherein p_{uncert} is the uncertainty value, wherein L_{old}(xⱼ) are second results of the conventional loss function, and wherein C_{penalty} is the penalty value.

13. The method of claim 11, wherein the updating the penalty value comprises evaluating the formula C_{penalty}=mean(L_{old}(x_{batch_j})), and wherein L_{old}(x_{batch_j}) are the first results of the conventional loss function.

14. The method of claim 13, wherein the updating the penalty value is prevented from dropping below a minimum value according to the formula C_{penalty}=max(C_{penalty}, Cₘᵢₙ) wherein Cₘᵢₙ is the minimum value.

15. The method of claim 11, further comprising tuning, by the system, the penalty value based on a mean of previous uncertainty values, wherein the tuning increments the penalty value by a first amount less than 1 in response to the mean of previous uncertainty values being less than a target value, and wherein the tuning decrements the penalty value by a second amount less than 1 in response to the mean of previous uncertainty values being greater than the target value.

16. A non-transitory machine-readable storage medium, comprising executable instructions that, when executed by a processor, facilitate performance of operations, comprising:
determining, based on inputs to a machine learning system, an uncertainty value that corresponds to an output of the machine learning system;
iteratively updating a penalty value of a loss function based on previous results of a conventional loss function;
iteratively adapting a machine learning model employed by the machine learning system based on the uncertainty value; and
correlating the output of the machine learning system with the uncertainty value to enable segregation of outputs of the machine learning system into at least first outputs comprising the output correlated to the uncertainty value and second outputs not comprising the output correlated to the uncertainty value.

17. The non-transitory machine-readable storage medium of claim 16, wherein the updating the penalty value improves an optimization of the loss function according to a defined performance criterion.

18. The non-transitory machine-readable storage medium of claim 17, wherein the loss function is L_{new}(xⱼ)=(1−p_{uncert})*L_{old}(xⱼ)+p_{uncert}*C_{penalty}, wherein p_{uncert} is the uncertainty value, wherein L_{old}(xⱼ) are current results of the conventional loss function, and wherein C_{penalty} is the penalty value.

19. The non-transitory machine-readable medium of claim 16, wherein the updating the penalty value comprises evaluating the formula C_{penalty}=max(mean(L_{old}(x_{batch_j})), Cₘᵢₙ), wherein C_{penalty} is the penalty value, wherein L_{old}(x_{batch_j}) are the previous results of the conventional loss function, and wherein Cₘᵢₙ is a minimum allowable penalty value.

20. The non-transitory machine-readable medium of claim 16, wherein the operations further comprise adjusting the penalty value based on a mean of previous uncertainty values, wherein the tuning increments the penalty value by a first amount less than 1 in response to the mean of previous uncertainty values being less than a target value, and wherein the tuning decrements the penalty value by a second amount less than 1 in response to the mean of previous uncertainty values being greater than the target value.
